(19) United States
(12) Patent Application Publication
(10) Pub. No.: US 2012/0173291 A1
(43) Pub. Date: Jul. 5, 2012

(54) Automated Claim Submission, Collection And Appeal For Denials

(76) Inventor: Julian Omidi, Las Vegas, NV (US)

(21) Appl. No.: 13/341,938

(22) Filed: Dec. 31, 2011

Related U.S. Application Data
(60) Provisional application No. 61/429,090, filed on Dec. 31, 2010.

(51) Int. Cl. G06Q 40/08

(52) U.S. Cl. 705/4

(57) ABSTRACT

The present invention is comprised of an automated claim submission, collection and appeal for denials for providing automated medical claims processing to a medical or surgery center or other form of medical facility. The present invention is further comprised of a database software system to record, store and process large volumes of data. The present invention is further comprised of modules that automatically perform the processing task include claims preparations and automatically filing appeals for claims denials.

### BACKGROUND

The past few decades have seen dramatic complexity evolving in health insurance coverage. Heath care providers face hundreds of pages of plan rhetoric to decipher to get the insurance companies to pay claims for medical service rendered to the patient who has been paying for the insurance coverage. In growing numbers insurance companies are just flat out refusing to pay claims cited one regulation or regional law after another. In some cases these citations are erroneous or just smoke screens to discourage the collection process. Health care providers and their staffs are faced with devoting an ever increasing share of their work hours to manually attacking the collections delays and denials rather than being able to use that same time with the patients for whom the health care is there to serve. The growing collections problem is reducing income while costs are increasing disproportionately due the added collections cost generated by the frequent insurance company delays and outright denials. An automated system for submitting claims in strict compliance with the volumes of insurance plan policies and automated collections and appeals process would relieve the added staffing burden and knock out the false underpinning of the erroneous delays and denials.

### BRIEF DESCRIPTION OF THE DRAWINGS

FIG. 1 shows a block diagram of an overview of an automated claim submission, collection and appeal for denials of one embodiment of the present invention.

FIG. 2 shows a block diagram of an overview flow chart of an automated claim submission, collection and appeal for denials and continues on FIG. 3 of one embodiment of the present invention.

FIG. 3 shows a block diagram of an overview flow chart continuing from FIG. 2 of an automated claim submission, collection and appeal for denials and continues on FIG. 4 of one embodiment of the present invention.

FIG. 4 shows a block diagram of an overview flow chart continuing from FIG. 3 of an automated claim submission, collection and appeal for denials of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

General Overview:

It should be noted that the descriptions that follow, for example, in terms of automated claim submission, collection and appeal for denials is described for illustrative purposes and the underlying system can apply to all types of health care payment claims for health care services. In this description the terms claims shall mean any request for payment whether for example it could be called an invoice, a bill, billing or other word or phrase that involves a demand for payment. In one embodiment of the present invention, the automated claim submission, collection and appeal for denials may include customized modules and capabilities to provide automated processing of claim preparation, automated appeals and other automated features and functions using the present invention.

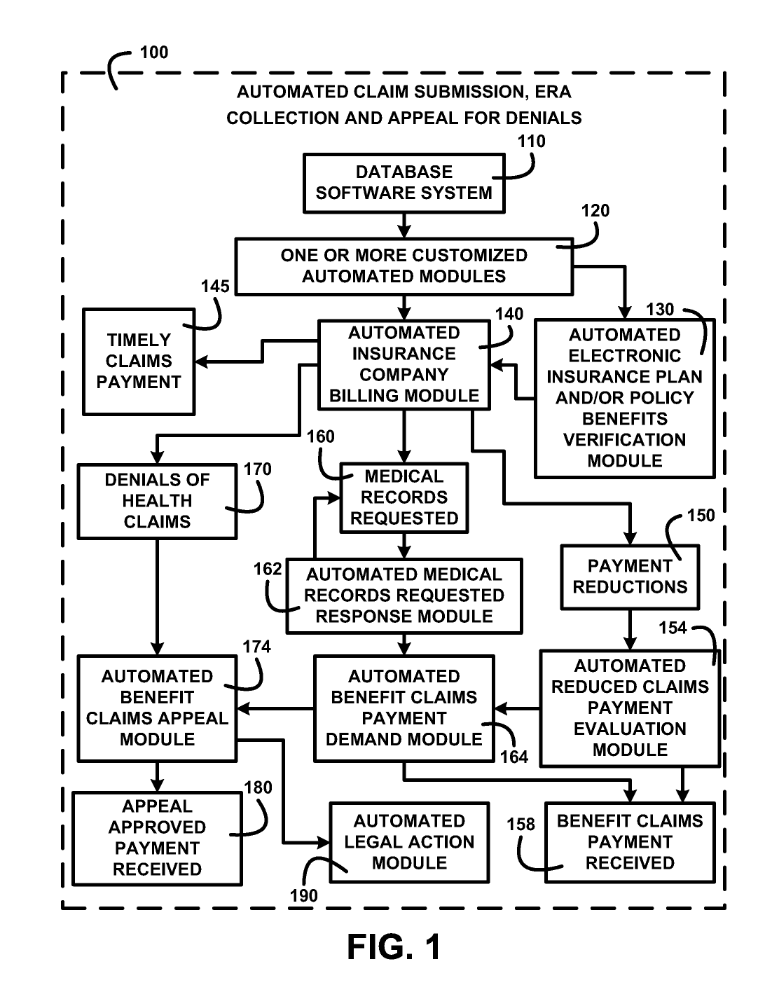

FIG. 1 shows a block diagram of an overview of an automated claim submission, collection and appeal for denials of one embodiment of the present invention. FIG. 1 shows an automated claim submission, collection and appeal for denials 100 configured to automatically process health insurance claims submission and when payment is denied or delay for questionable reasons the automated processes can be configured to prepare and file electronically appeals.

The automated claim submission, collection and appeal for denials 100 can be configured to include a database software system 110 to record and store data and operate one or more customized automated modules 120 to perform the processing functions. The one or more customized automated modules 120 can be configured to include an automated electronic insurance plan benefits verification module 130 to confirm benefits availability from the patient's insurance plan of one embodiment of the present invention.

The one or more customized automated modules 120 can be configured to include an automated insurance company billing module 140 to prepare and send electronically claims at the earliest opportunity when for example a medical procedure is completed. Some claims generated by the automated insurance company billing module 140 can result in benefit claims timely payment 145 from an insurance company. In other cases insurance company make payment reductions 150 on a claim. The one or more customized automated modules 120 can be configured to include an automated reduced claims payment evaluation module 154 to determine whether to accept the payment reductions 150. If the automated reduced claims payment evaluation module 154 decides to accept the reduced payment it is classified as a benefit claims payment received 158 or processed to an automated benefit claims payment demand module 164 to request the balance of the claim of one embodiment of the present invention.

On occasions an insurance company delays payment because of medical records requested 160. Federal law allows a specific time frame in which insurance company may make such a request. The automated medical records requested response module 162 determines if the request is within the allowable time frame. If it is the automated medical records requested response module 162 performs a search of the database software system 110 to select the records requested and sends them electronically. Should the automated medical records requested response module 162 find the request is beyond the allowable time frame it will transmit the request information to the automated benefit claims payment demand module 164 to automatically generate a demand for the payment citing the lapsed allowable time frame of one embodiment of the present invention.

The insurance companies can also make denials of health claims 170. The automated claim submission, collection and appeal for denials 100 can be configured to include an automated benefit claims appeal module 174 to prepare and file appeals using information searched from the insurance plan and/or policy on file. If the result is an appeal approved payment received 180 no further action takes place. If the appeal is unsuccessful one or more customized automated modules 120 can be configured to include an automated legal action module 190 to automatically prepare and file an action against the insurance company of one embodiment of the present invention.

Detailed Operation:

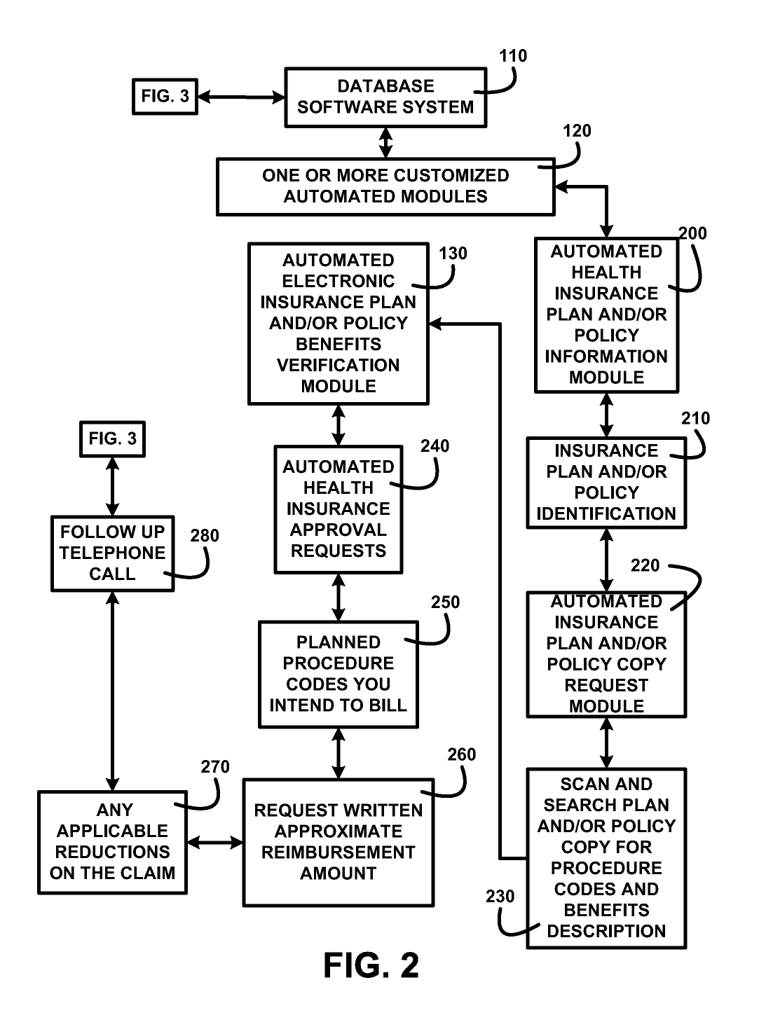

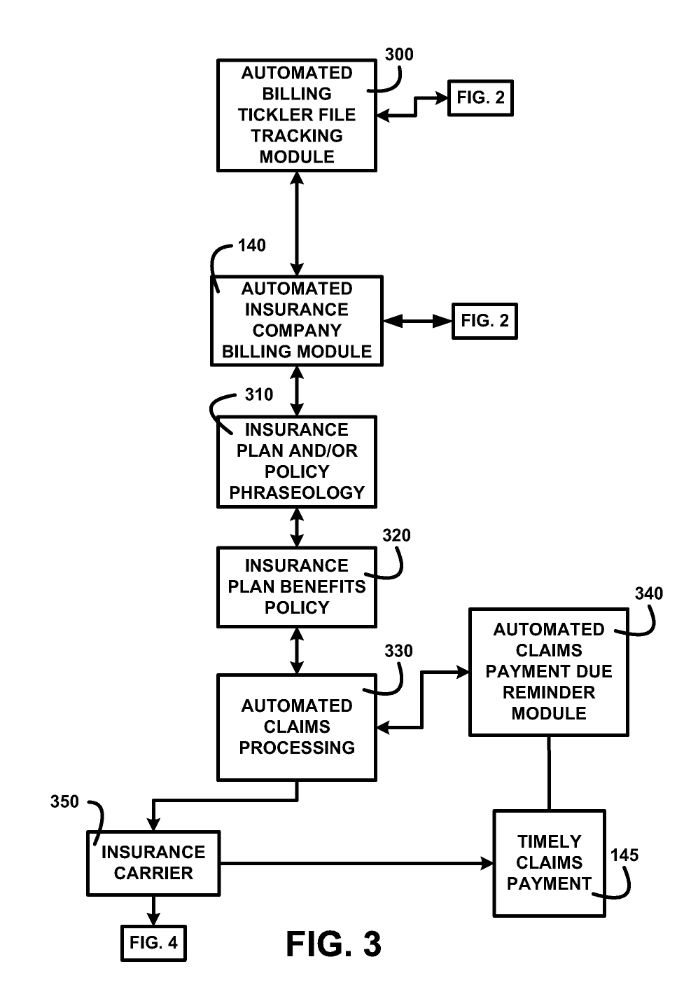

FIG. 2 shows a block diagram of an overview flow chart of an automated claim submission, collection and appeal for denials and continues on FIG. 3 of one embodiment of the present invention. FIG. 2 shows the automated claim submission, collection and appeal for denials 100 of FIG. 1 which can be configured to include the database software system 110. The database software system 110 can be configured to include one or more customized automated modules 120 of one embodiment of the present invention.

The one or more customized automated modules 120 can be configured to include an automated health insurance plan information module 200 to process data related to a plan and/or policy to determine the specific language of the plan and/or policy that will govern the filing of claims. The patient should supply an insurance plan identification 210 which can be used by an automated insurance plan policy copy request module 220 to get a copy for claims preparation. When the plan and/or policy is received the automated claim submission, collection and appeal for denials 100 of FIG. 1 can perform a scan and search policy copy for procedure codes and benefits description 230. The automated electronic insurance plan benefits verification module 130 can be configured to check whether the insurance plan identification provides by the patient is valid and whether the patient is covered. The one or more customized automated modules 120 can be configured to include an automated health insurance approval requests 240 module to process approvals for a medical procedure. The automated health insurance approval requests 240 module can determine planned procedure codes you intend to bill 250. This is helpful information to getting faster claim processing. When making an approval request the automated health insurance approval requests 240 module will automatically request written approximate reimbursement amount 260 and any applicable reductions on the claim 270 to be made. A follow up telephone call 280 can be made to confirm electronically obtained information as a recheck process. The process continues and is further described in FIG. 3 of one embodiment of the present invention.

Automated Insurance Company Billing Module:

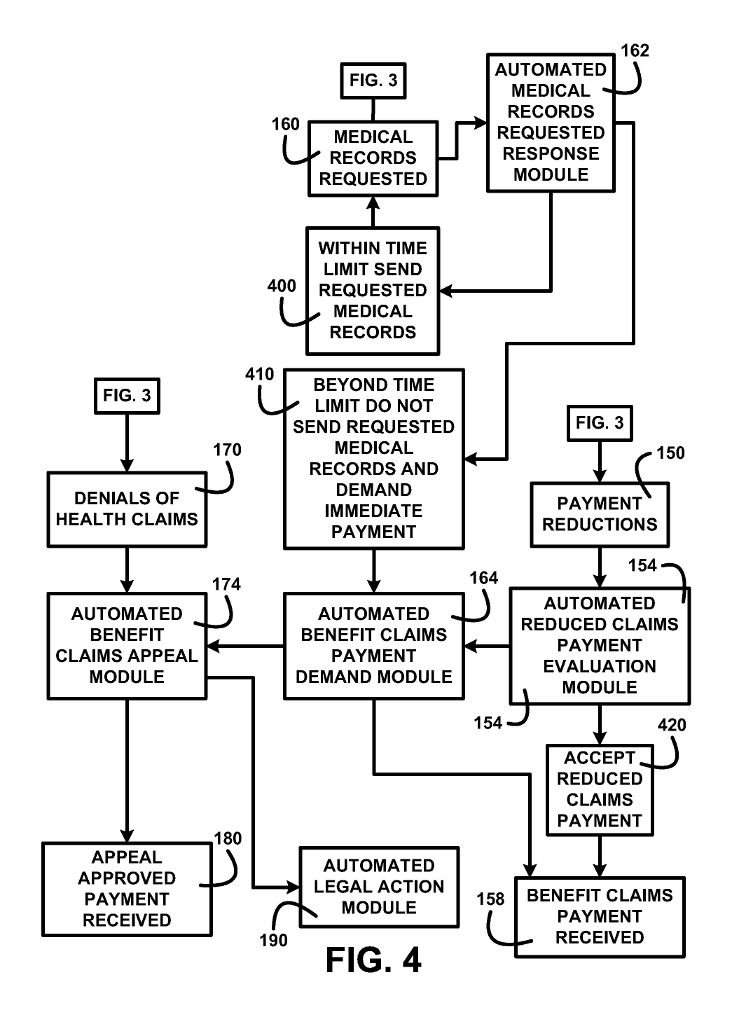

FIG. 3 shows a block diagram of an overview flow chart of an automated claim submission, collection and appeal for denials and continues on FIG. 4 of one embodiment of the present invention. FIG. 3 shows the process continuing from FIG. 2 with an automated billing tickler file tracking module 300 indicating that a procedure has been completed and is ready for claims processing. The automated insurance company billing module 140 receives the information from FIG. 2 and proceeds to prepare a claim. In the preparation of the claim the automated insurance company billing module 140 will search for and use insurance plan policy phraseology 310 scanned from an insurance plan benefits policy 320 to correctly describe the benefits, procedures and other pertinent information in the vernacular of the insurance company to prevent any misunderstandings of one embodiment of the present invention.

The automated insurance company billing module 140 prepared claim is further processed by an automated benefit claims processing 330 module. The automated benefit claims processing 330 modules records the claim in an automated benefits payment due reminder module 340 and then sends electronically the claim to the appropriate insurance carrier 350. If the insurance carrier 350 makes a timely claims payment 145 the process ends. If the insurance carrier 350 fails to make a timely claims payment 145 the process continues and is described in FIG. 4 of one embodiment of the present invention.

Automated Benefit Claims Appeal Module:

FIG. 4 shows a block diagram of an overview flow chart of an automated claim submission, collection and appeal for denials and continues on FIG. 3 of one embodiment of the present invention. FIG. 4 shows the continuation of the process in FIG. 3 if the payment is not made. An insurance carrier 350 of FIG. 3 may delay payment waiting for medical records requested 160. An insurance carrier 350 of FIG. 3 has time limitations set by Federal law in which to request medical records. In this circumstance an automated medical records requested response module 162 will check if the request is within time limit send requested medical records 400. If the request is timely the automated medical records requested response module 162 will perform a search for the request medical records and forward them automatically to the insurance carrier 350 of FIG. 3. If however the request is beyond time limit do not send requested medical records and demand immediate payment 410 the request will be process to the automated benefit claims payment demand module 164. If the demand letter generated by the automated benefit claims payment demand module 164 produces a benefit claims payment received 158 the process stops. If not the claim is processed to the automated benefit claims appeal module 174 to prepare and file an appeal. If an appeal approved payment received 180 is produced the process stops. If the appeal is denied and payment refused the automated legal action module 190 will prepare and file a legal action to secure payment through the courts of one embodiment of the present invention.

The claim processed in FIG. 3 may end up with the insurance carrier 350 of FIG. 3 making payment reductions 150. This is processed to the automated reduced claims payment evaluation module 154. Payments from the insurance companies are generally accompanied by a paper or electronic EOB which stands for explanation of benefits. The explanation can provide insight into the reasons for payment reductions and can be used in the preparation of an appeal. The payments are also generally made electronically as a direct deposit and the automated claim submission, collection and appeal for denials 100 of FIG. 1 can be configured to periodically search bank records electronically to locate claims payment and determine if they have been reduced .

The automated reduced claims payment evaluation module 154 can be configured to accept reduced payments to meet prescribe conditions and the process can accept reduced claims payment 420. If that determination is reached the payment is classified as a benefit claims payment received 158 and the process ends. Should the automated reduced claims payment evaluation module 154 determine not to accept the reduced payment the claim is processed to the automated benefit claims payment demand module 164 to prepare and send a demand letter which may end with a benefit claims payment received 158 and the process will end. Should no payment be produced by the demand process the claim is directed to the automated benefit claims appeal module 174 to file an appeal which may produce an appeal approved payment received 180 and the process will end. If the appeal is denied the automated legal action module 190 will file a legal action to recover the balance of the reduced claim payment of one embodiment of the present invention.

The billing process in FIG. 3 may result in denials of health benefits 170 claims payment which will prompt the automated benefit claims appeal module 174 to file an appeal to produce an appeal approved payment received 180 and if not process the denied claim to the automated legal action module 190 for preparation and filing of a legal action. The automated claim submission, collection and appeal for denials 100 of FIG. 1 processes rarely need the intervention of a staff member and can process large quantities of claims and the ancillary process to lead to their correct and timely submittals. The saving in staff cost, faster turn around of billable claims, the dogged tenacity to process collections actions untiringly is beyond a reasonable persons capacity to perform day and night every day of every week. The automated processes provide a front line defense against insurance company tactics to delay or deny claims and put a medical or surgery center at financial risk of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. An automated computer implemented collection and appeal method for denials for providing automated medical claims processing to a medical or surgery center or other form of medical facility that includes a database software system to record, store and process large volumes of data and modules that automatically perform the processing task include claims preparations and automatically filing appeals for claims denials.
